(19) United States
(12) Patent Application Publication
(10) Pub. No.: US 2016/0086269 A1
(43) Pub. Date: Mar. 24, 2016

(54) METHODS AND SYSTEMS FOR IMPROVED ORDER FILL RATES

(71) Applicant: Trading Technologies International Inc., Chicago, IL (US)

(72) Inventor: William Tigard Baker, Hoffman Estates, IL (US)

(21) Appl. No.: 14/494,416

(22) Filed: Sep. 23, 2014

(51) Int. Cl. G06Q 40/04

(52) U.S. Cl. CPC G06Q 40/04

(57) ABSTRACT

Example methods and systems for filling an order are disclosed herein. An example method includes identifying a first order for a first tradeable object in a queue, the first order having a first quantity and a first price. The example method includes determining an equivalency between the first tradeable object and the first price and a second tradeable object and a second price of a second order in the queue. The example method includes, if an equivalency is determined, generating a composite order based on the first order and the second order. The composite order is to be recognized by an exchange. The example method includes receiving a filled composite order from the exchange configured to process the generated composite order. The example method includes delivering a first portion of the filled composite order as the first order and a second portion of the filled composite order as the second order.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

In pro-rata markets, orders are typically filled based on price and quantity. Larger quantity orders are often filled first before smaller quantity orders for the same tradeable object and price.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example system for combining orders in which certain embodiments may be employed.

FIG. 5 illustrates a block diagram of another example system for combining orders in which certain embodiments may be employed.

FIG. 6 is a block diagram of an example processing system that can be used to implement the embodiments disclosed herein.

FIG. 7 is a flow diagram of an example method for combining orders.

FIG. 8 is an example diagram illustrating an implementation of the example method of FIG. 9.

FIG. 9 is a flow diagram of another example method for combining orders.

FIG. 10 is an example diagram illustrating an implementation of the example method of FIG. 8.

FIG. 11 is a flow diagram of another example method to combine orders.

FIG. 12 is a flow diagram of example method for filling a combined order.

FIG. 13 is a flow diagram of an example method for dividing a combined order.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

In financial exchanges, a plurality of trade orders are received from traders, some of which are for the same tradeable object (e.g., product) at the same price, but differ with respect to quantity. Different financial exchanges use different rules for assigning a priority to each order in queue for filling the orders at the exchange. In a pro-rata market, orders are generally filled based on price, quantity, and time. In some examples, if there are two or more orders for the same object at the same price, trades are allocated to the orders proportionally according to quantity. Thus, in pro-rata markets, a smaller quantity order is at a disadvantage with respect to a larger quantity order, even if the smaller quantity order was received at the exchange prior to the larger quantity order.

To increase efficiency in filling a smaller quantity order without substantially compromising a priority of a larger quantity order, the smaller quantity order can be combined or merged with the larger quantity order to generate a combined, or composite order. The composite order, which includes the quantity of both the smaller order and the larger order, can be filled at the exchange based on the exchange's priority rules and then divided after filling for delivery of the respective quantities of the smaller and larger orders to their respective trading devices. Thus, the smaller order benefits from the association with the larger order as part of the composite order in that the composite order can be filled sooner than if the second order was a stand-alone order. Further, in some examples, the larger order can benefit from the association with the smaller order due to the increased quantity and resulting increase in priority of the composite order at the exchange. Therefore, transactional speeds of completing both the smaller and larger orders are increased within the exchange.

In some examples, orders are combined by identifying matches, commonalities, similarities, and/or equivalencies in one or more order attributes or characteristics, including an object for which the order is placed, object price, and the like. For example, if two orders are identified as associated with the same tradeable object at the same price, a composite order can be generated by combining by the quantities of the two orders and cancelling the original orders. Alternatively, the larger order can be modified by increasing the quantity of the larger order by the quantity of the smaller order and cancelling the smaller order. The composite order, or the order having the combined quantity, can receive a higher priority in the exchange queue based on increased quantity, thereby resulting in faster filling of the respective orders of the combined order, for example.

One or more rules or guidelines provide for flexibility in combining orders based on various criteria, including, for example, order matching criteria, time periods for identifying opportunities to combine orders, considerations for price adjustments after a combined order is formed, etc. Also, users are provided with an ability to set permissions with respect to whether an order should be considered for combining with another order. Permissions can also be set based on, for example, how an order's position in the priority queue will be affected by combining orders. Such opt-in/opt-out thresholds to participate in order combining provide for further flexibility in combining orders while also maintaining a degree of user control.

In some examples, apart from combining the orders to fill the orders, the orders are otherwise treated as substantially separate orders from the perspective of, for example, trading applications. Thus, there is minimal disruption to the orders from the viewpoint of the trading system and the users. Accuracy of the respective orders is maintained by a digest, or recordation, of the attributes of the respective orders forming the composite order that is automatically generated upon combining the orders and referenced upon splitting the filled composite order for delivery. Further, an integrity of the orders is preserved by considering privacy and security restrictions with respect to different brokers, companies, and/or exchange credentials so that orders are combined within, for example, the same company or based on similar exchange credentials rather than across brokerages if regulations and/or trading norms prohibit it.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Certain embodiments provide a method including identifying a first order for a first tradeable object in a queue, the first order having a first quantity and a first price. The example method includes determining an equivalency between (1) the first tradeable object and the first price and (2) a second tradeable object and a second price of a second order in the queue. The example method includes, if an equivalency is determined, generating a composite order based on the first order and the second order. The composite order is to be recognized by an exchange. The example method includes receiving a filled composite order from the exchange configured to process the generated composite order. The example method includes delivering a first portion of the filled composite order as the first order and a second portion of the filled composite order as the second order.

Certain embodiments provide a tangible computer-readable storage medium comprising instructions that, when executed, cause a machine to at least identify a first order for a first tradeable object in a queue, the first order having a first quantity and a first price. The example instructions cause the machine to determine an equivalency between (1) the first tradeable object and the first price and (2) a second tradeable object and a second price of a second order in the queue. If an equivalency is determined, the example instructions cause the machine to generate a composite order based on the first order and the second order. The composite order is to be recognized by an exchange. The example instructions cause the machine to detect a filled composite order received from the exchange configured to process the generated composite order. The example instructions cause the machine to deliver a first portion of the filled composite order as the first order and a second portion of the filled composite order as the second order.

Certain embodiments provide a system including a computing device including a processor configured to identify a first order for a first tradeable object in a queue, the first order having a first quantity and a first price. The example processor is configured to determine an equivalency between (1) the first tradeable object and the first price and (2) a second tradeable object and a second price of a second order in the queue. If an equivalency is determined, the example processor is configured to generate a composite order based on the first order and the second order. The composite order is to be recognized by an exchange. The example processor is configured to detect a filled composite order received from the exchange configured to process the generated composite order. The example processor is configured to deliver a first portion of the filled composite order as the first order and a second portion of the filled composite order as the second order.

### II. EXAMPLE ELECTRONIC TRADING SYSTEM

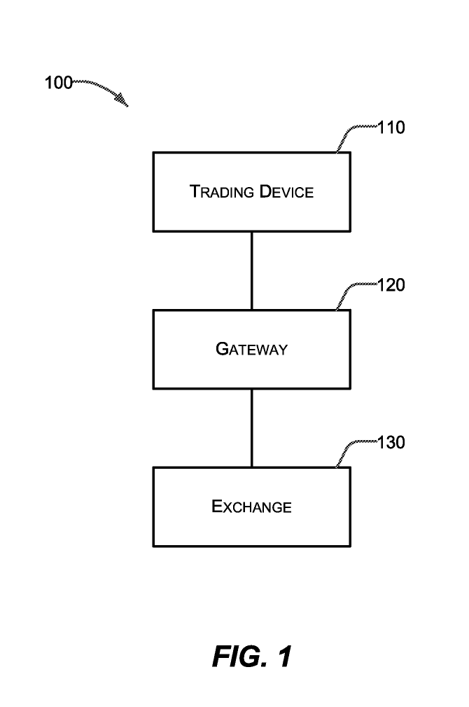

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

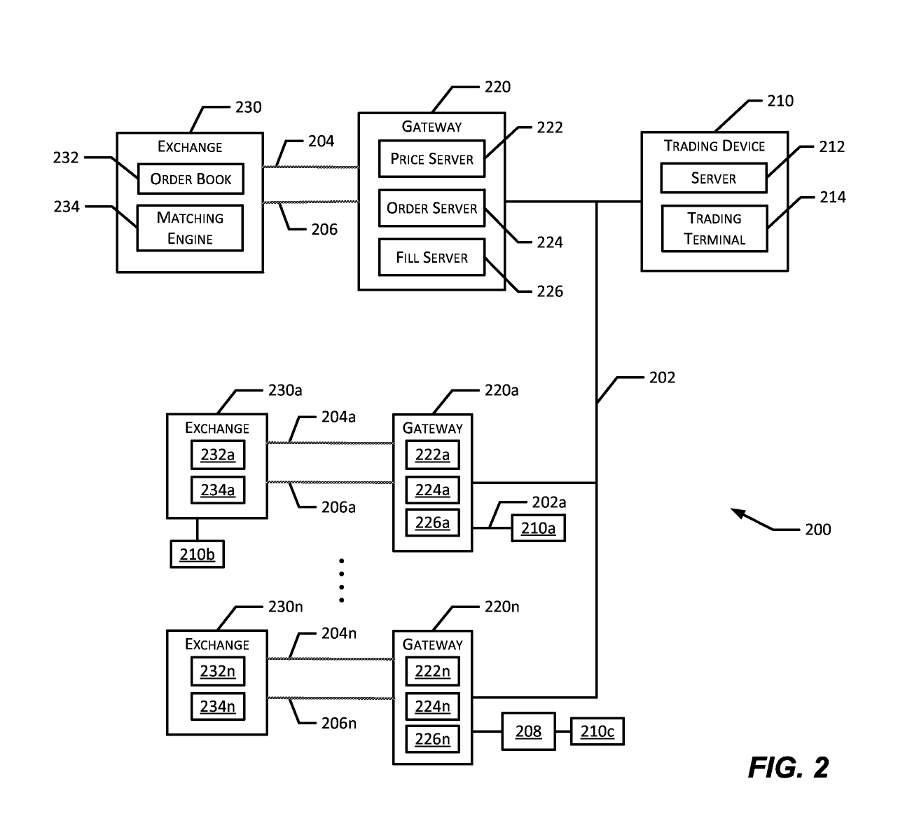

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

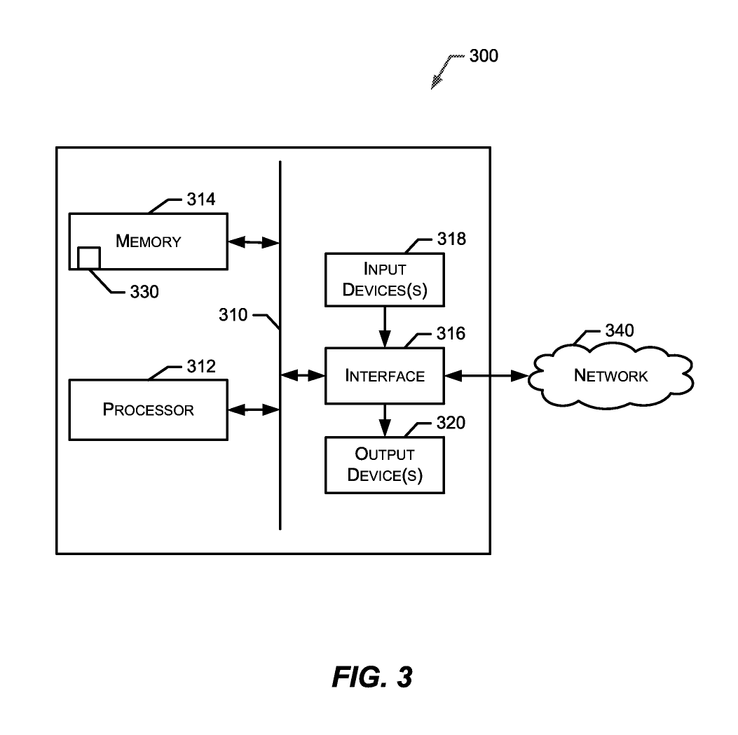

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. EXAMPLE ORDER FILLING SYSTEMS AND METHODS

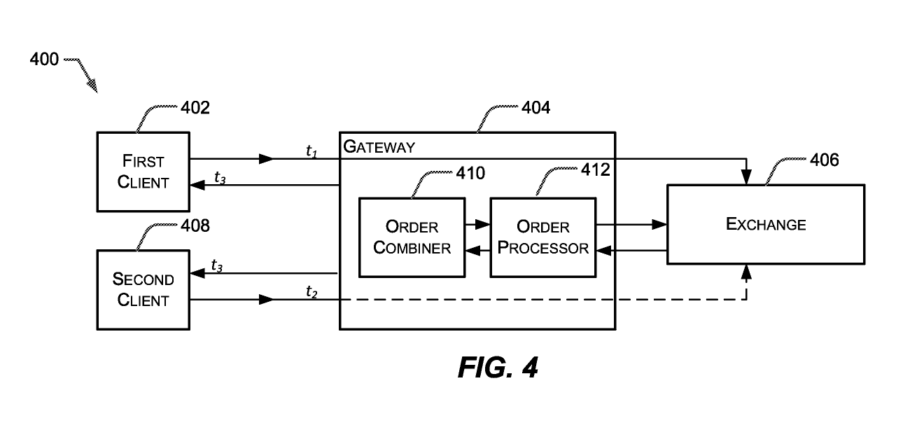

Example methods and systems to combine two or more orders based on tradeable objects, object prices, and/or object quantities associated with the respective orders are disclosed herein. FIG. 4 shows an example system 400 for combining orders. In the example system 400, a first client 402 (e.g., the trading device 110, 210 of FIGS. 1 and 2) sends a first order, which is received at a gateway 404 at a first time t₁. The gateway 404 communicates with an exchange 406 to transfer the first order to the exchange 406. The first order sent by the first client 402 is an order for a first tradeable object at a first price and for a first quantity to be filled by the exchange 406. The first price can be an absolute price or a relative price, for example.

The example system 400 includes a second client 408 (e.g., the trading device 110, 210 of FIGS. 1 and 2). The second client 408 sends a second order, which is received at the gateway at a second time t₂. In the example system 400, the second order is for the first tradeable object at the first price and for a second quantity. In some examples, the second quantity is different than the first quantity. As an example, in the system 400 of FIG. 4, the second quantity of the second order sent by the second client 408 is less than the first quantity of the first order sent by the first client 402. In other examples, the second quantity can be equal to the first quantity. The second time t₂ can be earlier than, after, or substantially equal to the first time t₁. In some examples, the second order is communicated to the exchange 406 substantially upon receipt at the gateway 404. In other examples, the second order is held at the gateway 404 for consideration as to whether the second order should be combined with another order. Also, the example system 400 can include additional clients sending orders to the gateway 404.

In some examples, when orders such as the first order and the second order are received at the gateway 404 via the first and second clients 402, 408, the orders are processed separately by the gateway and filled by the exchange 406 based on one or more rules. In such examples, the second order is communicated to the exchange 406 for processing as an independent order. For example, the gateway 404 processes price data and order data for the first order and the second order, as disclosed in connection with the gateway 220 of FIG. 2 above. The gateway communicates with the exchange 406, which fills the first and second orders. In examples where the exchange is a pro-rata market, the first order is assigned a first priority in an exchange queue for filling the first order based on the first quantity. The second order is assigned a second priority in the exchange queue for filling the second order based on the second quantity. In examples where the second quantity is less than the first quantity, the second priority of the second order is less than the first priority of the first order. Thus, the first order would be filled first and the second order would be filled after the first order.

In other examples, the second order is reviewed as to whether the second order should be combined with, for example, the first order such that the first order and the second order are filled as a combined order. The review of the second order for combining with the first order can occur when the second order is at the gateway 404 (e.g., not yet sent to the exchange 406) or when the second order is at the exchange 406. To consider whether the second order should be combined with the first order, the gateway 404 of the example system 400 includes an order combiner 410. The order combiner 410 detects one or more attributes of the first order sent by the first client 402 and the second order sent by the second client 408. For example, the order combiner detects the first tradeable object, the first price, and the first and second quantities of the respective first and second orders. The order combiner 410 can detect the one or more attributes of the first and second orders prior to the orders being sent to the exchange 406 (e.g., when an order is received at gateway 404) and/or after one or more of the first order or the second order is sent to the exchange 406. In some examples, the order combiner 410 is in communication with one more other components of the gateway 404, such as the price server 222 and the order server 224 as disclosed in connection with the electronic trading system of FIG. 2. The order combiner 410 compares the attributes of the first order and the second order to identify matches, commonalities, or substantial similarities between the first order and the second order. For example, the order combiner 410 compares the tradeable objects and prices associated with the first order and the second order and identifies that the first order and the second order are for the same tradeable object and the same price. The order combiner 410 also compares and identifies differences in the quantities of the respective orders. In some examples, the order combiner 410 detects whether one or more the first order or the second order have been partially filled by exchange.

In the example system 400, the order combiner 410 combines, or merges, the first quantity of the first order and the second quantity of the second order based on the comparison of the first and second orders and the identification that the orders are for the same tradeable object and the same price. For example, if the second order previously was sent to the exchange and the order combiner 410 identifies that the first order and the second order share substantial similarities (e.g., same tradeable object, same price), the order combiner 410 can combine the first order and the second order to generate a new combined order for the first tradeable object at the first price. The combined order has a quantity equal to the first quantity of the first plus the second quantity of the second order. In some examples, the order combiner 410 cancels the first order and the second order and processes the combined order as a new order. In other examples, the order combiner 410 merges the second order with the first order and cancels the second order such that the second order is no longer to be filled as a separate order by the exchange 406. Thus, the first order is modified in that the first quantity is increased by the second quantity. The order combiner 410 records the attributes of the first order and the second order that make up the composite order. For example, attributes such as the quantity of each order and the client(s) from which each order originated are recorded in a digest.

If the second order has not yet been sent to the exchange, the order combiner 410 can increase the quantity of the first order by the quantity of the second order to form the composite order. In such examples, the second order is not transmitted to the exchange for filling as a separate order, as the increase in the quantity of the first order is attributable to the second order. The order combiner 410 records that order at the exchange 406 (e.g., originally the first order) is now a composite of the first and second order.

The gateway 404 processes the combined order generated by the order combiner 410 via an order processor 412. The order processor 412 can include, for example, the price server 222, the order server 224, and/or the fill server 226 as disclosed in connection with FIG. 2. The order processor 412 treats the combined order substantially the same as the order processor 412 would treat the first order and/or the second order if the orders were separate from one another. For example, the order processor 412 processes the combined order into a data format understood by the exchange 406.

In the example system 400, the order processor 412 is in communication with the exchange 406. The exchange 406 recognizes the combined order (e.g., identifies as an order submitted for filling) and/or receives the combined order and treats the combined order as a working order until the combined order is filled or cancelled. The exchange 406 fills the combined order based on a priority assigned to the combined order in view of the quantity of the combined order and other orders to be filled by the exchange.

After the combined order is filled, the gateway 404 facilitates delivery of the first order and the second order to the first and second clients, respectively. To deliver the first and second orders, the order combiner 410 splits the quantities of the objects of the filled combined order (e.g., the fills of the combined order) based on the respective quantities of the first order and the second order. For example, the order combiner 410 divides the fills of the combined or composite order by referencing the digest, which includes the recordation of the respective quantities of the first and second orders. In some examples, the order combiner 410 divides the fills of the composite order as they are received from the exchange. The gateway 404 delivers the filled first order to the first client 402 and the filled second order to the second client 408. In the example system 400, the filled first order and the filled second order are delivered at substantially the same time t₃. Thus, in the example system 400, although the second order was submitted for a lesser quantity and may have been submitted to the gateway 404 at a later time than the first order, the filled second order is received by the second client 408 at substantially the same time as the filled first order is received by the first client 402. Therefore, in the example system 400, the second order benefitted from an association with the first order via the composite order. The order combiner 410 can advantageously be used in connection with a variety of trading schemes for matching or billing where an increased order quantity can provide a benefit (e.g. an increased priority filling as described above, exchange fees, etc.).

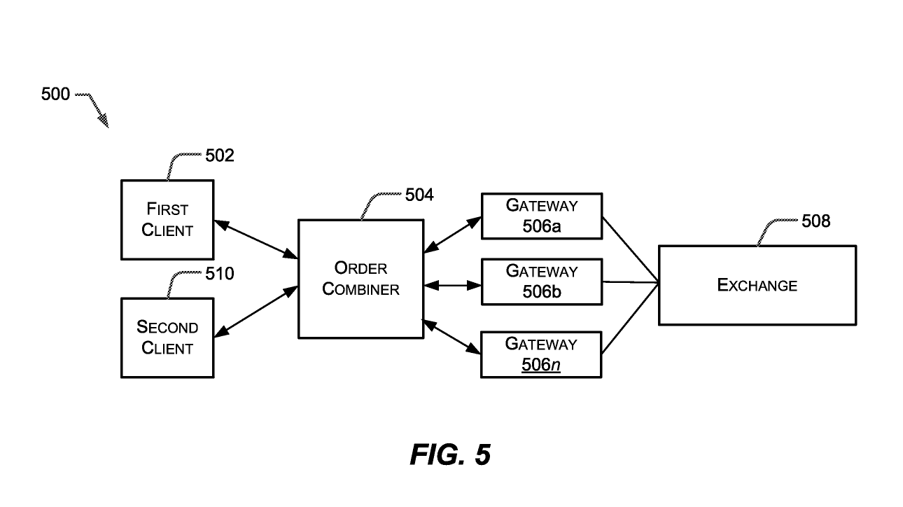

FIG. 5 is a block diagram of another example system 500 for combining orders. In the example system 500, a first client 502 (e.g., the trading device 110, 210 of FIGS. 1 and 2) sends a first order for a first tradeable object at a first price and for a first quantity. The first price can be an absolute price or a relative price, for example.

The order combiner 504 is in communication with one or more gateways 506a-506n. In the example system 500, the order combiner 504 is independent from the gateways 506a-506n (e.g., the order combiner 504 resides separately from the gateways 506a-506n). The order combiner 504 can be a dedicated server for combining orders or reside on another server in communication with the one or more gateways 506a-506n. The gateways 506a-506n are in communication with an exchange 508 for transferring the first order to the exchange 508 for filling. In another example, each of the gateways 506a-506n may be in communication with one or more additional exchanges such as the exchange 508. In some examples, the first order is received at the order combiner 504 (e.g., for identification as potential candidate for order combining). In other examples, the first order is received directly at one of the gateways 506a-506n. In such examples, the order combiner 504 can recognize the existence of the first order for consideration as a potential candidate for order combining.

A second client 510 (e.g., the trading device 110, 210 of FIGS. 1 and 2) sends a second order for the first tradeable object at the first price and for a second quantity to the order combiner 504. In some examples, the second quantity is different than the first quantity. In the example system 500, the second quantity of the second order sent by the second client 510 is less than the first quantity of the first order sent by the first client 502. The second order can be received at one of the gateways 506a-506n (e.g., the first gateway 506a) and identified by the order combiner 504 for consideration with respect to combining the second order with another order. The second order can be transferred to the exchange 508 or evaluated for combining with another order prior to being sent to the exchange 508.

The order combiner 504 processes the first and second orders substantially as described above in connection with the order combiner 410 of FIG. 4. For example, the order combiner 504 compares the first and second orders to identify commonalities and/or differences in the tradeable objects, prices, and/or quantities. In the example system 500, the order combiner 504 identifies that the first order sent by the first client 502 and the second order sent by the second client 504 are for the same tradeable object at the same price, but different quantities. Based on the determination that the first and second orders are for the same tradeable object at the same price, the order combiner 510 combines, or merges, the first order and the second order to form a composite order. The order combiner 504 combines the first and second order by, for example, creating a new order for the first tradeable object at the first price having a quantity equal to the first and second quantities and cancelling the first and second orders. Alternatively, the order combiner 504 can modify the first order by increasing its quantity by the second quantity and cancelling the second order if the second order was previously sent to the exchange 508 or preventing the second order from being sent to the exchange 508 if the second order has not yet been sent to the exchange 508. The order combiner 504 records the attributes of the first order and the second order such as quantity of each order in, for example, a digest.

The first gateway 506a and/or the exchange 508 process the combined order in substantially the same manner that the first gateway 506a and/or the exchange 508 would process the first order and/or the second order if the orders were received separately. For example, the first gateway 506a can include the price server 222 as disclosed in connection with FIG. 2 to process price data associated with the combined order. The first gateway 506a processes the combined order into a data format understood by the exchange 508. The first gateway 506a sends the combined order to the exchange 508, which can be a pro-rata exchange, for example. The combined order is placed in a queue for filling based on a priority associated with, for example, the quantity of the combined order. In the examples, the exchange 508 adjusts the priority of the composite order relative to the priority of the first order before the first order was increased by the quantity of the second order. The exchange 508 fills the combined order.

After the combined order is filled, the filled combined order is received at, for example, the first gateway 506a. The first gateway 506a can additionally process the filled combined order by transforming the market data associated with the combined order from an exchange-specific format to a format understood by the first and second client 502, 510. The first gateway 506a can include a fill server 226 as disclosed in connection with FIG. 2 to provide a record of the filling of the combined order.

In the example system 500, the filled combined order is transferred from the first gateway 506a to the order combiner 504. The order combiner 504 splits the quantity acquired via the filled combined order based on the individual quantities of the first order and the second order by referencing, for example, the previously recorded digest. The order combiner 504 delivers the filled first order to the first client 502 and the filled second order to the second client 510. In other examples, the portions of the first order and the second order are delivered to the respective first client 502 and the second client 510 by the first gateway 506a. In the example system 500, although the second order was submitted for a lesser quantity, the filled second order is received by the client at substantially the same time as the filled first order. Therefore, in the example system 500, the second order benefitted from its association with the first order.

As described in connection with the example systems 400, 500 of FIGS. 4 and 5, the operative placement of the order combiner relative to the order gateway is flexible within a system. For example, as disclosed in connection with FIG. 4, the order combiner 410 can reside on the order gateway 404. Alternatively, as shown in FIG. 5, the order combiner 504 can be a server that resides separately from, but is in communication with one or more gateways. Further, the order combiner 504 can be a dedicated server or part of another server that perform additional function(s). Thus, the example order combiner 410, 504 can flexibly reside at different locations within a system between the clients and the exchange such that the order combiner 410, 504 can consider orders to potentially combine that are associated with one or more gateways 404, 506a-506n and/or exchanges 406, 508.

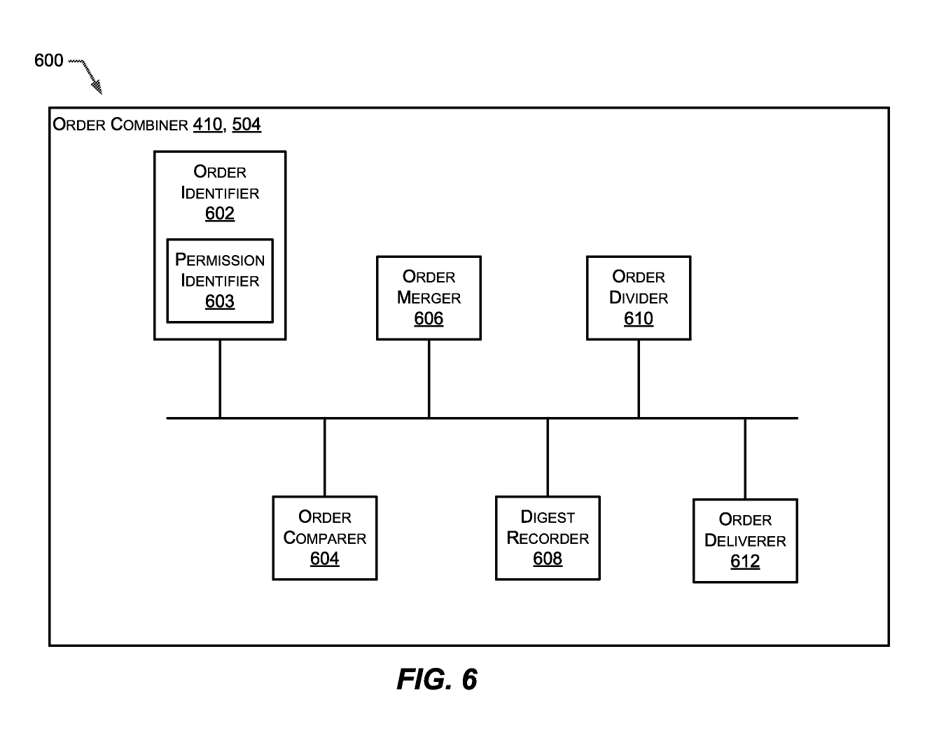

FIG. 6 is a block diagram of an example processing system 600 for implementing an order combiner, such as the order combiners 410, 504 of the example systems 400, 500 of FIGS. 4 and 5. The example processing system 600 includes an order identifier 602. The order identifier 602 identifies or detects one or more orders received by the order combiner 410, 504 or the gateways 404, 506a-506n, and/or transmitted to the exchanges 406, 508 via one or more clients (e.g. the first client 402, 502 and/or the second client 408, 510 of FIGS. 4 and 5). The order identifier 602 can identify one or more attributes associated with the respective orders, such as tradeable objects, object price, and/or object quantity.

In some examples, the order identifier 602 also detects whether an order is authorized or permitted to be combined with another order. For example, a user (e.g., a trader) can selectively define an eligibility for an order to be combined with another order by setting permissions that allow, selectively allow, or prevent the order combiner 410, 504 from merging the order with another order. The permissions can be based on one or more rules, setting, or security parameters, such as, for example, the tradeable object for which the order is submitted, a time frame, an effect that combining the order with another order will have on time in which the order is filled, credentials such as company or brokerage association, privacy restrictions, etc. By setting permissions for an order, a user can selectively decide whether an order is available for order combining by the order combiner 410, 504 and an extent to which the order is eligible for such combining.

For example, a user can set a permission via a trading device (e.g., the first and/or second clients 402, 502, 408, 510) to allow the order combiner 410, 504 to combine a first order with another order (e.g., a second order). In such examples, the permission identifier 603 will detect that the first order is eligible to be combined with another order. The permission identifier 603 can allow the order combiner 410, 504 to further process the first order to identify the first order as a candidate for combining with another order (e.g., by comparing the attributes associated with the first order with attributes of other orders). In some examples, the permission identifier 603 flags the first order as an order eligible for order combining. In other examples, the permission identifier 603 does not flag the first order as eligible for order combining but instead, for example, allows the first order to proceed for further processing by the order combiner 410, 504.

In some examples, a user may decide to selectively allow the first order to participate in order combining by the order combiner 410, 504. For example, the user can set a permission (e.g., via the trading device) that allows the first order to be eligible for combining with another order for a predefined period of time. In such examples, if another order that shares one or more attributes with the first order (e.g., the same tradeable objects, substantially the same price) is not available within the predefined period of time, then the first order is filled as an independent or stand-alone order. The permission identifier 603 identifies that the first order is associated with a predefined period of time for eligibility for order combining and flags or marks the first order having a qualified permission. For example, the permission identifier 603 can trigger a counter to determine when the predefined time period has expired.

As another example of criteria that can define selective eligibility of an order for order combining, a user can set a permission that allows the first order be combined with another order if the quantity of the first order will increase by a predefined threshold amount as a result of the combining. Such a permission allows the user to limit combining the first order with other orders to the extent that the combined quantity falls below the threshold. For example, a user can restrict order combining eligibility based on a quantity threshold if the user would prefer that the first order is filled independently unless the quantity, and, thus, the priority of the order filling, increases by a certain amount.

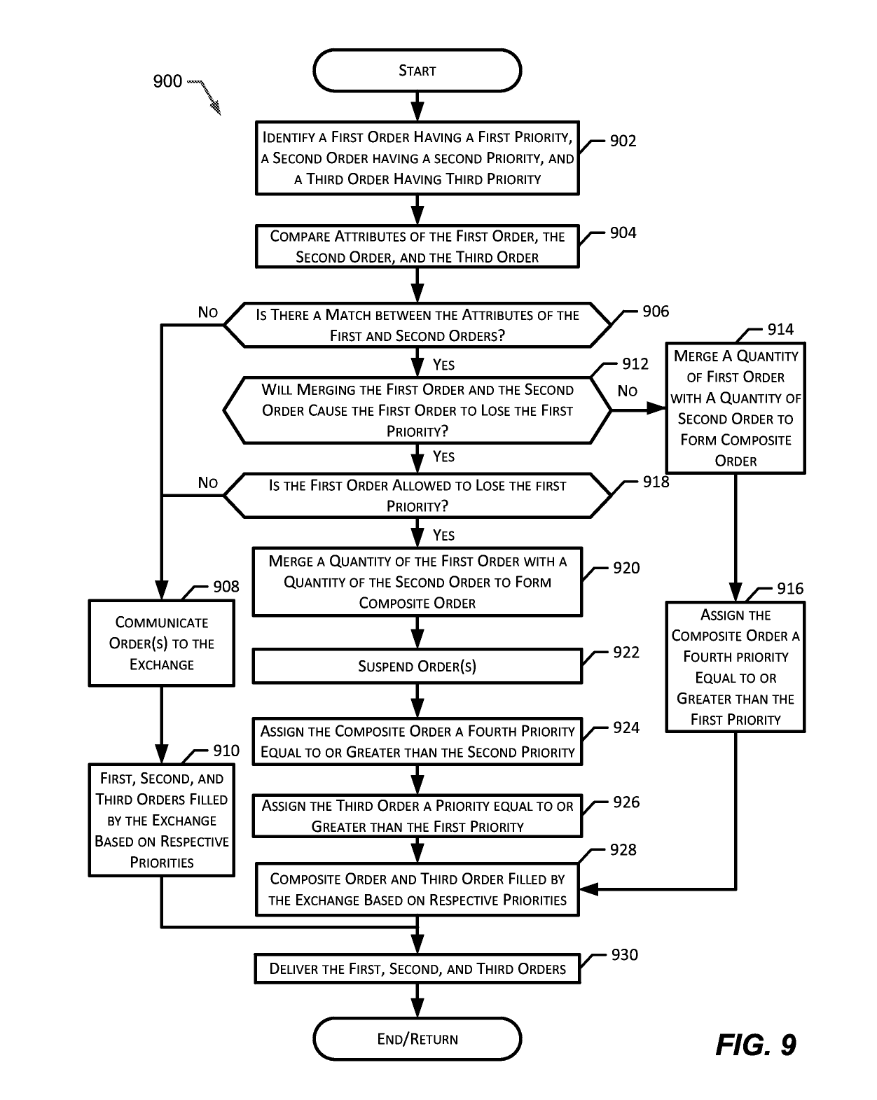

A user can also set a permission that selectively allows the first order to be combined with another order based on an effect that combining the first order with the other order will have on the priority of filling the first order at the exchange (e.g., a placement of the first order in the exchange queue). In some examples, as will be disclosed below in connection with FIG. 9, combining the first order with a second order that is for a lesser quantity than the first order can reduce the priority of the first order. For example, the combined first and second order may be assigned a priority behind a third order that is not combined with another order. If the first order originally had a higher priority than the third order, then although combining the first order with the second order benefits the second order, the user may consider the effect on the priority from the perspective of the first order (e.g., the reduced priority) to be risk that the user would prefer not to take. Thus, the user can set a permission that prevents the first order from being combined with the second order if the net effect of the priority is to lessen the priority of the first order in the queue for order filling at the exchange. In such examples, the permission identifier 603 identifies the selective permission associated with the first order and flags the first order for a determination as to the effect of combining the first order with the second order on the priority of the first order before permitting the combination.

In other examples, a user may decide to make the first order ineligible for combining with another order. For example, the user may opt-out of combining the first order with one or more other words by denying permission for order combining via, for example, the trading device. In such examples, the permission identifier 603 detects that the first order is ineligible for order combining. In some examples, the permission identifier 603 flags the first order as an order ineligible for order combining such that the order combiner 410, 504 does not further process the first order. In other examples, the permission identifier 603 does not flag the first order as ineligible for order combining but instead, for example, blocks the first order from proceeding for further processing by the order combiner 410, 504.

The example system 600 also includes an order comparer 604. The order comparer 604 performs comparisons between the attributes of the first order and one or more other orders identified by the order identifier 602 to determine if there are matches, commonalities, and/or substantial similarities between the attributes of the order. For example, the order comparer 604 compares the tradeable object of the first order with the tradeable object of a second order. If the first and second orders are for the same tradeable object, the order comparer 604 compares the prices associated with the respective orders to identify substantial similarities in prices. If, for example, the first and second orders are for the same tradeable object at the same price, the order comparer 604 compares quantities associated with the orders to determine if the first order and the second order are candidates for combining. For example, the order comparer 604 can detect that the first order is for a relatively large amount of a certain tradeable object whereas the second order is for a lesser amount of the same tradeable object. In other examples, the order comparer 604 identifies whether the first order and/or the second order have been partially filled by the exchange. Based on the differences in quantities, the order comparer 604 identifies the first and second orders as candidates for merging to increase the priority of the second order in view of the larger quantity, and, thus, the higher priority, of the first order for filling by the exchange.

The order comparer 604 performs comparisons based on the identification of permissions by the permission identifier 603. For example, if an order is not allowed to be combined, the order comparer 604 will not consider the attributes of that order. If the order is selectively permitted to be combined, the order comparer 604 may compare order quantities to determine if, for example, a quantity threshold is met. The order comparer 604 also compares other factors between orders such as whether the orders are to be filled by the same exchange or whether the orders were submitted by the same broker or the same company.

The example system 600 also includes an order merger 606. The order merger 606 combines or merges the quantities of the orders identified as candidates for combining by the order comparer 604 based on the comparisons of the order attributes as well as the permissions for combining identified by the permission identifier 603. In some examples, the order merger 606 combines a first order and a second order by generating a new (e.g., separate) order for the tradeable object at a price submitted by the first and second orders and for a quantity equal to the first and second orders. In such examples, the order merger 606 cancels the first and second orders. In other examples, the order merger 606 modifies the first order by increasing the quantity by the amount of the first order by the quantity of the second order and cancelling the second order if the second order was previously sent to the exchange or preventing the second order from being sent to the exchange if the second order has not yet been sent to the exchange. The order merger 606 can combine two or more orders in other ways than those examples described herein as well.

The example system 600 also includes a digest recorder 608. The digest recorder 608 records data about the orders that are combined by the order merger 606 in a digest or summary. The digest provides a mapping from the individual orders that make up the composite order and vice versa. In some examples, the digest recorder 608 assigns a unique identification (e.g., a number) with the orders that are to make up the composite order. The identification assigned to the individual orders can be, for example, an identification that identifies the composite order at the exchange or a derivation thereof (e.g., an identification assigned to the composite order by the exchange). Using the identification, all orders associated with the composite order can be retrieved by querying for the assigned identification.

In some examples, the digest recorder 608 records additional information about the individual orders, such as attributes associated with each order. For example, the digest recorder 608 records the quantity, tradeable object, price, originating client or trading device, etc. for each of the first and second orders. The digest recorder 608 can record information about a company or a broker from which the respective orders originated. The digest recorder 608 can also record permissions and/or restrictions as to how an order can be combined as identified by the permission identifier 603 (e.g., time limits for considering the order for combining, limitations on quantity increases, etc.). Recording such information accounts for client authorizations associated with each order to facilitate trading within a scope defined by the trader.

The digest recorder 608 also information related to combining the orders and filling the composite order. The digest recorder 608 records the manner of combining the orders by the order merger 606 such as whether one or the orders was modified or whether one or more orders were cancelled or held from being sent to the exchange. The digest recorder 608 records whether the first order and/or the second order were partially filled prior to being combined. The digest recorder 606 can record other data, such as when the combined order was sent to the exchange, at what time the orders were combined, the quantity each order contributed to the quantity of the composite order, and/or any processing rules associated with the composite order (e.g., how the filled composite order is to be distributed among the individual orders). The digest recorder 606 stores the data for each order in, for example, a database. In some examples, the digest recorder updates the stored data during processing of the composite order based on adjustments to the first, second, and/or composite orders by the user and/or the system (e.g., the systems 400, 500 of FIGS. 4 and 5).

The example system 600 also includes an order divider 610. As disclosed above in connection with FIGS. 4 and 5, after the combined order is filled at the exchange, the combined order is transferred (e.g., returned) to the order combiner 410, 504. The order divider 610 divides or splits the fills of the combined order for delivery to, for example, the first client 402, 502 and the second client 408, 510 of FIGS. 4 and 5. The order divider 610 divides the fills of the combined order based on the respective quantities of the orders associated with or forming the combined order. To divide the fills of the combined order based on the quantities, the order divider 610 references the digest prepared by the digest recorder 608. For example, the order divider 610 can query for the identification assigned to the composite order to determine which orders make up the composite order and their associated attributes, such as the quantity of each order and to which clients the filled orders should be delivered.

The example system 600 also includes an order deliverer 612. The order deliverer 612 delivers the filled orders to the respective clients. The order deliver 612 delivers the filled orders based on the data related to the originating client for each order as recorded by the digest recorder 608. The order deliverer 612 delivers the filled orders as separate orders in that from the perspective of the first and second clients, the first and second orders are delivered without an indication that they were treated as a combined order by the exchange. Thus, whether the order merger 606 created a new combined order and cancelled both of the first and second orders or modified one of the first or second orders and cancelled the other of the orders, the order deliverer delivers the filled first order to the first client and the filled second order to the second client as separate orders.

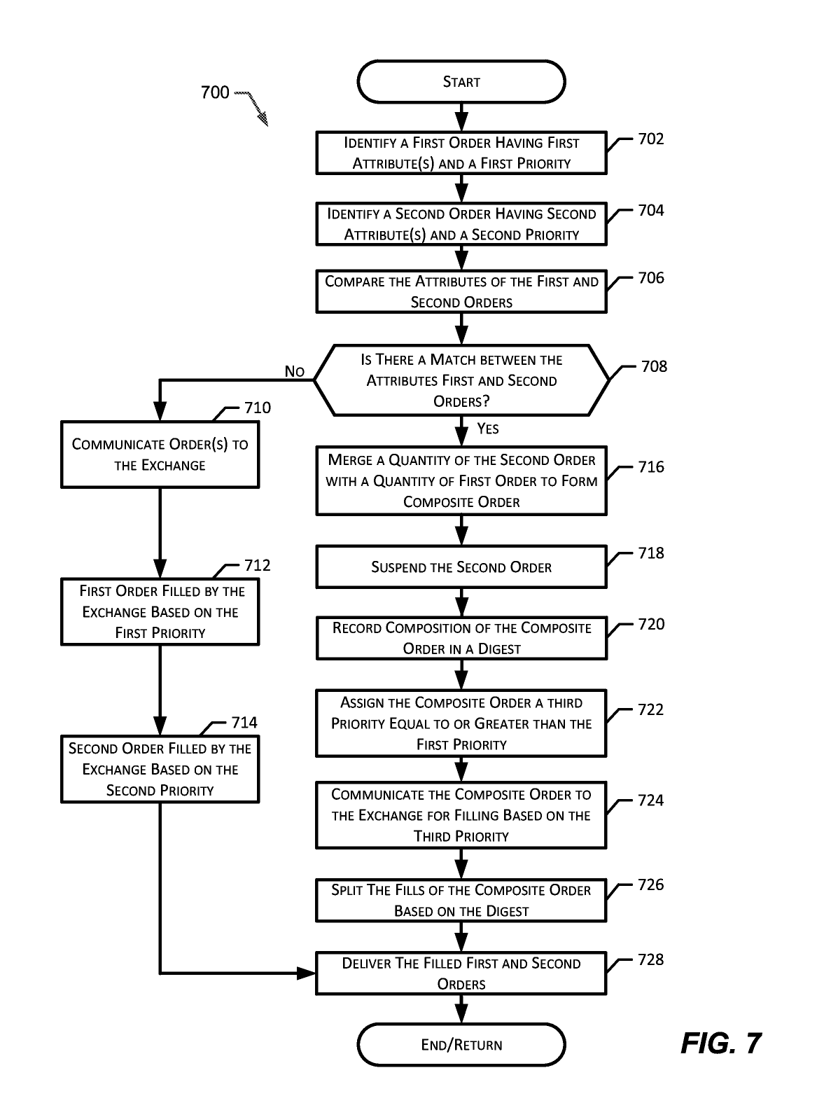

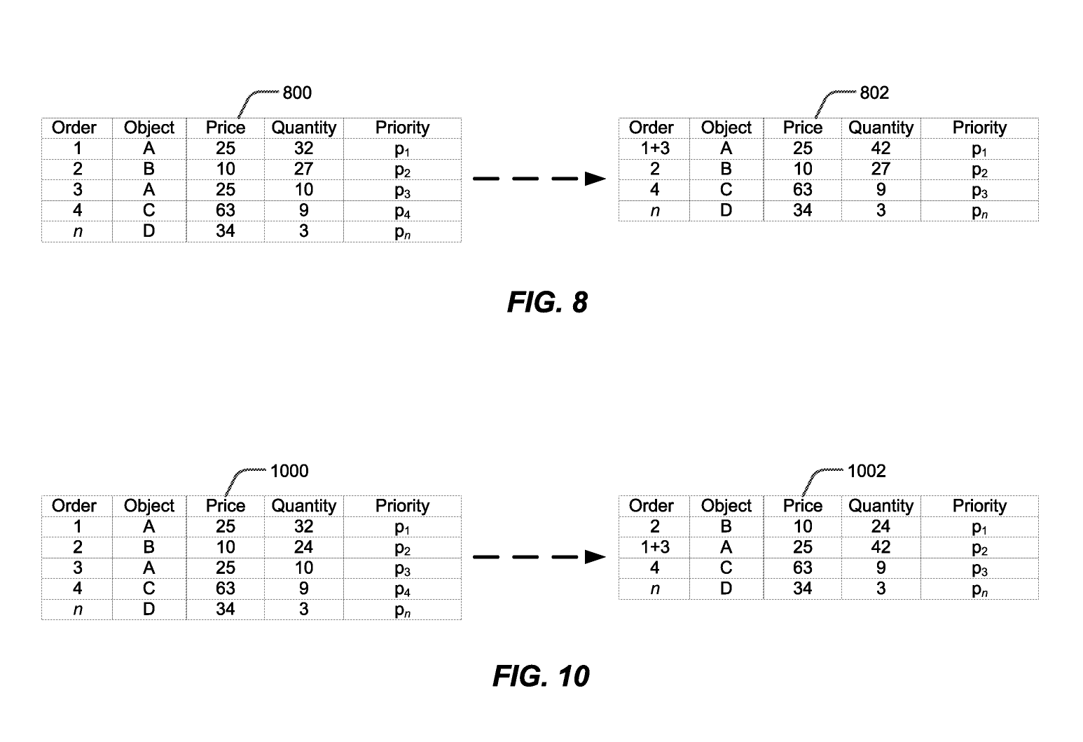

FIG. 7 is a flow diagram of an example method 700 for combining orders. FIG. 8 is an example diagram illustrating an implementation of the example method 700 of FIG. 7. The example method 700 includes identifying a first order having one or more attributes and a first priority (block 702). The first order can be received at an order gateway (e.g., the gateway 404 of FIG. 4) or an order combiner server (e.g., the order combiner 504 of FIG. 5) from a first client (e.g., the first client 402, 502 of FIGS. 4, 5). The first order can be transmitted to an exchange (e.g., the exchange 406, 508 of FIGS. 4, 5). In the example method 700, the first order is identified by the order identifier 602 of FIG. 6, which detects the one or more attributes associated with the first order, such as a first tradeable object for which the first order was submitted and a price at which the first tradeable object is sought to be purchased. In some examples, the order identifier 602 identifies permissions associated with the first order via the permission identifier 603.

In the example method 700, the first priority of the first order is identified and/or assigned by the order identifier 602. For example, if the first order is to be filled by a pro-rata market exchange where orders are filled based on price and quantity, the first priority of the first order can be assigned based on the quantity of the first order. The first priority determines a placement of the first order in a queue for filling the first order by the exchange in view of other orders to be filled by the exchange. The first priority can be based on other criteria besides or in addition to quantity, such as price or time of receipt of the first order by the exchange.

The example method 700 also includes identifying a second order having one or more second attributes and a second priority (block 704). The second order can be received at an order gateway (e.g., the gateway 404 of FIG. 4) or an order combiner server (e.g., the order combiner 504 of FIG. 5) from a second client (e.g., the second client 408, 510 of FIGS. 4, 5). The second order can be transmitted to the exchange or not yet transmitted to the exchange. In the example method 700, the second order is identified by the order identifier 602 of FIG. 6, which detects the one or more attributes associated with the second order, such as a second tradeable object for which the second order was submitted and a price at which the second tradeable object is sought to be purchased. In some examples, the order identifier 602 identifies permissions associated with the second order via the permission identifier 603. In the example method 700, the order identifier 602 can identify a plurality of different orders at block 704 (e.g., a third order, a fourth order, etc.)

The second order has a second priority that is identified or assigned by the order identifier 602 and is representative of the placement of the second order in the queue for filling the second order at the exchange. In some examples, the second priority of the second order is based on the quantity of the second order. For example, if the quantity of the second order is less than the quantity of the first order, the second order may have a lower priority (e.g., ranking) in the exchange queue than the first order.

In the example method 700, the attributes of the first and second orders are compared (block 706). For example, the order comparer 604 of FIG. 6 compares the tradeable objects and the prices associated with the first and second orders. The order comparer compares the quantities for which each order was submitted. In comparing the attributes of the first and second orders, the order comparer 604 determines whether there are any commonalities or matches between the attributes of the first order and the attributes of the second order. In the example method 700, the order comparer determines whether there is a match between the first and second tradeable objects and the prices of the first and second orders.

As an illustrative example of an implementation of the method 700 of FIG. 7, a first table 800 of FIG. 8 shows sample order data for a plurality of first through n orders submitted to the gateway 404 of FIG. 4 and/or the order combiner 504 of FIG. 5 via one or more trading devices (e.g., clients). As shown in the first table 800, a first order (“Order 1”) is associated with a tradeable object A at a price of $25 per object and a quantity of 32 objects. A second order (“Order 2”) is associated with a tradeable object B at a price of $10 per object and a quantity of 24 objects. A third order (“Order 3”) is associated with the tradeable object A at a price of $25 per object and a quantity of 10 objects. In the example first table 800, Order 1 is assigned a priority (e.g., a time for filling the order) of p₁ based on the quantity of the order as compared to the other orders in the table (e.g., Order 1 is for the largest quantity of tradeable objects). The other orders are also assigned a priorities based on the quantities of each order as compared to the other orders. Thus, in some examples, the first table 800 represents a queue for filling the first through n orders at the exchange based on order quantity.

Implementation of the example method 700 of FIG. 7 with respect to the sample data of FIG. 8 includes identifying (e.g., via the order identifier 602) the first through n orders in the first table 800, the attributes associated with the orders (e.g., object, price, quantity), and the priority for each order (e.g., blocks 702, 704 of FIG. 7). In the example method 700, the attributes of two or more of the first through n orders are compared to identify similarities between the attributes (block 706). For example, the order comparer 604 of FIG. 6 compares the object and price of Order 1 with the object and price of Order 2. The order comparer 604 also compares the object and price of Order 1 with the object and price of Order 3. Thus, in the example method 700, the order comparer 604 can compare the first order to multiple orders received by the order combiner 410, 504 to determine if there are any similar or matching orders and/or order attributes.

In the example method 700, a determination is made whether there is a match between the attributes of the first and second orders (block 708). For example, referring to first table 800 of FIG. 8, based on the comparisons of the first through n orders, the order comparer 604 determines that there is a match between the objects and prices of Order 1 and Order 3. In some examples, the order comparer 604 may identify that the quantities of Order 1 and Order 3 also match if Order 1 and Order 3 were submitted for the same quantity of object A.

If there is not a match between the first order and the second order (or any other orders received at the order combiner), then the example method 700 continues with communicating one or more the of the first order and the second order to the exchange (e.g., the exchange 406, 508 of FIGS. 4 and 5) for filling of the orders by the exchange as separate orders (block 710) if the first order and/or the second order have not previously been transferred to and/or recognized by the exchange for filling. The exchange fills the first order based on the first priority (block 712) and the second order based on the second priority (block 714). For example, if there was not a match between Order 1 and Order 3 in the first table 800 of FIG. 8 (e.g., one or more of the objects or the prices of Order 1 and Order 3 differed), then Order 1 would be filled by the exchange before Order 3 based on the associated priorities in view of the quantities of the orders.

In other examples, if there is not a match between the first order and the second order, the example method 700 can include searching for one or more other orders to combine with the first order and/or the second order.

If, as described in connection with first table 800 of FIG. 8, a match is identified between attributes of two or more orders, the example method 700 continues with merging the quantity of the second order with the quantity of first order to form a composite order (block 716). Merging the quantities of the second order with the first order can be performed by the order merger 606 of FIG. 6. In the example method 700, the order merger 606 modifies the first order by adding the quantity of the second order to the first order and suspending the second order (block 718). If the second order has not yet been sent to the exchange prior to merging the second order with the first order, suspending the second order can include preventing the second order from being transmitted to the exchange so that the second order is not sent to the individually and as part of the composite order. If the second order was previously sent to the exchange prior to being combined with the first order, suspending the second order can include cancelling the second order so that the exchange no longer recognizes the second order as an independent order to be filled. In other examples, the order merger can create a new or separate composite order for object, price, and quantities of the first and second orders and cancel the first and second orders. In other examples, the order merger 606 can queue or otherwise hold one or both of the first and second orders while the new composite order is created. Orders that have been queued or held may be released and processed when the corresponding composite order is filled or partially filled and a quantity is allocated to one or more of the held orders.

The example method 700 includes recording a composition of the composite order in a digest (block 720). For example, the digest recorder 608 of FIG. 6 records the attributes of the first and second order that form the composite order. The digest recorder 608 also records the trading device from which each of the first and second orders originated. The digest recorder 608 can record other information associated with the first order and/or the second order (e.g., the first and second priorities, the time when the first and second orders were identified by the order identifier, etc.). If the first order and the second order were both at the exchange when the composite order was formed, the digest recorder 608 records that the composite order is a combination of the first order and the second order. If the second order as not previously sent to the exchange but the first order was previously sent to the exchange, the digest recorder 608 records that the first order at the exchange is now a composite order that has an increase quantity corresponding to the quantity of the second order.

In the example method 700, the composite order is assigned a third priority (e.g., a placement or ranking in the queue for being filled by the exchange) (block 722). The assignment can be performed by the order combiner (e.g., the order identifier 602 and/or the order merger 606 of FIG. 6). The third priority is equal to or greater than the first priority of the first order prior to forming the composite order. In the example method 700, the second order can benefit as a result of the association with the first order, as the second order, which may previously have had a priority that was less than the first priority due to a smaller quantity of the second order, now has a priority that is at least as high as the first order. In some examples, the composite order is assigned a priority that is higher than the first priority originally associated with the first order. For example, as a result of adding the second quantity to the first quantity, the composite order may have a quantity that is greater than another order (e.g., a third order) in the queue. In such examples, the first order benefits from the association with the second order as part of the composite order because the priority of the first order also increases.

Referring again to FIG. 8 as an illustrative example of an output of the method 700 of FIG. 7, based on the determination that Order 1 and Order 3 share common attributes with respect to object and price, the order merger 606 merges the quantity of Order 3 (e.g., a quantity of 10) with the quantity of Order 1 (e.g., a quantity of 32) such that the composite order of Order 1 plus and Order 3 has a quantity of 42. A second table 802 of FIG. 8 shows the order data after the merging of Order 3 with Order 1 to form the composite order and the cancellation of Order 3. As shown in the second table 802, the composite order is assigned the priority of the first order, p₁. Thus, in the implementation of the example method 700 illustrated in FIG. 8, Order 3 benefits from the association with Order 1, as Order 3 has increased a positioning or ranking in the queue for order filling by exchange (e.g., the priority of Order 3 increased relative to Order 2).

In the example method 700, the composite order is communicated to the exchange as an order for filling based on the third priority (block 724). The composite order can be communicated to the exchange via one more network connections between the order combiner (e.g., the order combiner 410, 504 of FIGS. 4, 5), the order gateway (e.g., the gateways 404, 506a-506n of FIGS. 4, 5), and the exchange (e.g., the exchange 406, 508 of FIGS. 4, 5). At the exchange, the composite order of FIG. 8 is filled with a quantity of 42 of the object A at a price of $25 per object.

After the composite order is filled at the exchange, the composite order is returned to, for example, the order combiner 410, 504 via one or more network connections. The order combiner splits the filled quantities, or the fills, of the composite order into a filled first order and a filled second order based on the digest (block 726). In some examples of the method 700, the order divider 610 splits the fills of the composite order as disclosed in connection with FIG. 6.

The example method 700 includes delivering the filled first order and the filled second orders to the respective clients (block 728). In some examples, the order deliver 612 of FIG. 6 delivers the first filled order and the second filled order via, for example, network connections between order combiner and the trading device(s) from which the orders originated or are associated. After delivery of the orders, the example method 700 can end or return to identifying other orders received by the order combiner.

In the example method 700, the filled first order and the filled second order are delivered as separate orders. Similarly, in examples where there is no match between the first order and the second order and the first and second orders are filled independently based on the respective first and second priorities (blocks 710-714), the first and second orders are also delivered as separate filled orders (block 728). However, when the second order is merged with the first order, the second order has a higher priority and may be filled faster than if the second order were not combined with the first order. In examples where the second order is filled independently, the second order may have to wait until after other orders (e.g., larger quantity orders) are filled. Thus, there is the risk that the object, the available price, and/or the quantity are not available when the second order reaches the start of the queue for filling. Thus, although filling of the composite order may not be guaranteed in view of the activity at the exchange (e.g., the exchange activity related to filling other orders at the exchange), combining orders as described in connection with the example method 700 provides the second order with an advantage in the exchange as compared to the second order were queued in the exchange alone.

FIG. 9 is a flow diagram of another example method 900 for combining orders. FIG. 10 is an example diagram illustrating an implementation of the example method 900 of FIG. 9. The example method 900 includes identifying a first order having a first priority (e.g., placement or ranking) in an order filling queue, a second order having a second priority in the order filling queue, and a third order having a third priority in the order filling queue (block 902). In some examples, the first through third priorities are based on a quantity of tradeable objects for which the respective first through third orders are submitted. The example method 900 can include identifying additional orders (e.g., an nth order). The first through third orders can be identified by the order identifier 602 as substantially disclosed in connection with the example system 600 of FIG. 6 and the example method 700 of FIG. 7 (e.g., block 702). Also, one or more the first, second, or third orders can be at the exchange or residing at a gateway.

Each of the first, second, and third orders has one or more attributes such as a tradeable object for which the order is submitted, an object price, and an object quantity. The example method 900 includes comparing the attributes of the orders (block 904). For example, the order comparer 604 of FIG. 6 compares the tradeable objects, prices, and quantities associated with the respective first, second, and third orders to identify similarities or matches between one or more attributes of the orders, as substantially disclosed in connection with the example method 700 of FIG. 7 (e.g., block 704).

In the example method 900, a determination is made whether there is a match between the attributes of, for example, the first order and the second order (block 906). For example, the order comparer 602 of FIG. 6 can determine whether there is a match between the object and price of the first order and the second order. The order comparer 602 can also determine whether there is a match between the first order and third order and/or the second order and the third order.

If a match is not identified between, for example, the first order and the second order (or between any of the first, second, third orders and/or other orders), the example method 900 continues with communicating the first, second, and third orders to the exchange (block 908). For example, if any of the first, second, or third orders have not yet been sent to the exchange, then communicating the order(s) can include transferring the order(s) to the exchange. In other examples, the communication can include an indication that one or more the orders at the exchange should be filled as independent orders. The first, second, and third orders are filled by the exchange based on their respective priorities (block 910). For example, if the first priority of the first order is greater than the second priority of the second order, the first order will be filled by the exchange before the second order.

If a match is identified between, for example, the first order and the second order (or between any of the first, second, third orders and/or other orders), the example method 900 continues with determining an effect of merging the first order with the second order on priority of the first order (block 912). As described above in connection with the permission identifier 603 of FIG. 6, in some examples, a user can selectively allow the first order to be combined with another order (e.g., an order for a lesser quantity), if the combining does not affect the priority or placement of the first order in the exchange queue. In the example method 900, a determination is made whether merging the first order with the second order will cause the first order to lose the first priority such that the priority of the first order as part of a composite or combined order will be less than if the first order was not combined with the second order.

For example, if the second order is submitted for a quantity equal to the first order, then combining the first and second orders may not affect the first priority of the first order. Instead, the composite order may be assigned a priority equal to or greater than the first priority based on the increased quantity associated with the composite order formed from the first and second orders. In such examples, the example method 900 includes merging the quantity of the first order with the second order to form a composite order (block 914). The composite order is assigned a fourth priority for filling at the exchange equal to or greater than the first priority (block 916). In such examples, the composite order and associated priority may be similar to the illustrative data of the example second table 802 of FIG. 8.

In other examples, merging the first order with the second order does cause the first order to lose the first priority. For example, based on one or more rules of the order combiner 410, 504, the gateways 404, 506a-506n, and/or the exchanges 406, 508 of FIGS. 4 and 5, two or more orders may be combined, however, the composite order may be assigned a priority that is less than a priority assigned to an order that has not been combined. In some examples, to prevent disadvantaging orders that are not eligible for combining and/or for which there are no other orders submitted for the same or similar objects or prices relative to the combined order(s), one or more rules adjusts or balances the priorities of the combined order(s) in view of the orders that are not combined. Such adjustments can include switching a priority ranking of a combined order with a non-combined order so that the non-combined order has a higher priority in the queue, despite the lesser quantity as compared to the composite order. The adjustments can be performed by the order combiner (e.g., the order identifier 602 and/or the order merger 606 of FIG. 6).

As an illustrative example of order switching, FIG. 10 includes a first table 1000 having first through n orders with associated objects, prices, and quantities. Also, the first through n orders have associated priorities that are representative of a ranking in which the first through n orders are filled by the exchange. As shown in the first table 1000 of FIG. 10, a first order (“Order 1”) has is associated with a tradeable object A at a price of $25 per object and a quantity of 32 objects. Order 1 has a priority of p₁ based on the quantity of the order as compared to the other orders in the table. A second order (“Order 2”) is associated with a tradeable object B at a price of $10 per object and a quantity of 24 objects and is assigned a priority of p₂, which is less than the priority of Order 1. A third order (“Order 3”) is associated with the tradeable object A at a price of $25 per object and a quantity of 10 objects and is assigned a priority of p₃, which is less than the priority of Order 1 and Order 2.

Following the example method 900, a match is identified between the objects and prices of Order 1 and Order 3 (e.g., block 906). Thus, Order 1 and Order 3 can be candidates for forming a composite order to increase, for example, a priority of Order 3 in view of its lesser quantity. One or more rules associated with the order combiner may balance the combining of orders and resultant priorities with the priority levels of non-combined orders. For example, combining Order 1 and Order 3 results in an increased quantity (e.g., a quantity of 42). However, rather than assigning the composite order formed from Orders 1 and 3 a priority that is equal to or higher than the priority of Order 1 (e.g., p₁), one or more rules can result in the switching of the priority levels of composite order with the non-combined Order 2 such that Order 2 has a higher priority than the composite order. Thus, Order 1 would have lesser priority as part of the composite order than if Order 1 was not combined with Order 3.

If the priority level of an order such as Order 1 is affected (e.g., reduced) as described above, then the example method 900 includes a determination if the first order is allowed to lose the first priority (block 918). For example, the permission identifier 603 of FIG. 6 can flag the first order as being subject to selective authorization for combining based on one or more user settings.

If the first order is not allowed to have reduced priority as a result of merging with another order, then the example method 900 transfers the first order and second order to the exchange for filling as independent orders (e.g., blocks 908, 910). In other examples, the example method 900 can include identifying other orders for combining with the first order that will not reduce the priority of the first order as part of a composite order.

If the first order is permitted to have a reduced priority as part of a composite order (or if such an allowance is a default setting), the example method 900 continues with merging the quantity of the first order with the quantity of the second order (block 920). In the example method 900, the composite order is formed by creating a new order for the tradeable object associated with the first order and the second order at the price of respective orders and for a quantity equal to the quantities associated with the respective orders. The attributes of the first and second orders are record in a digest (e.g., by the digest recorder 608 of FIG. 6). Thus, in the example method 900, one or more of the first and second orders are suspended in favor of the new composite order (block 922). Suspending the first order and/or the second order can include cancelling the first and/or second orders or holding the first and/or second orders while the new composite order is created and releasing the orders when the composite order has been filled or partially filled and respective quantities have been allocated to the orders. However, in other examples, the composite order can be created by modifying the first order with the quantity of the second order and suspending the second order, as described in connection with the example method 700 of FIG. 7 (e.g., blocks 716, 718).

In the example method 900, the composite order is assigned a fourth priority equal to or greater than the second priority (block 924). The assignment can be performed by the order combiner (e.g., the order identifier 602 and/or the order merger 606 of FIG. 6). As noted above, the second priority may be less than first priority. Thus, in the example method 900, there is a risk that the first order will be associated with a lower priority as part of the composite order and thus, may be filled by the exchange at a later time than if the first order was filled independently. As an illustrative example, the third order, which is not associated with the composite order, is assigned a priority that is equal to or greater than the first priority (block 926). Thus, in some examples, the third order can be filled before the composite order despite having a lesser quantity. However, in other examples, the priority of the third order does not change, is assigned a priority that is less than the first priority, and/or is assigned another priority in view of attributes of one or more other orders at the exchange, which can include orders other than the first, second, and third orders, and/or in view of one or more rules or algorithms (e.g., for queuing and filling orders) associated with the exchange. Thus, in some examples, the third order may not be filled before the composite order.

Referring to FIG. 10, a second table 1002 illustrates the effect of balancing priorities between combined orders and non-combined orders. For example, as shown in the second table 1002, Order 2, which is not combined with another order is assigned the priority that was previously associated with Order 1 (e.g., p₁) and the composite order formed from Order 1 and Order 3 is assigned a priority that is lower than the priority of Order 2 (e.g., p₂).

The composite order and the third order are filled by the exchange based on the respective priorities (block 928). For example, referring again to the example second table 1002 of FIG. 10, Order 2 would be filled by the exchange in advance of the composite order created from Order 1 and Order 3. Alternatively, in examples where the priority of the first order is not affected by merging with the order (e.g., blocks 914, 916), the composite order may be filled in advance of the third order based on the associated priorities (e.g., as substantially described above in connection with the second table 802 of FIG. 8).

In the example method 900, whether the first, second, and third orders are filled independently (e.g., blocks 908, 910) or as part of a composite order (e.g., blocks 914, 916 and 920-928), the first, second, and third orders are delivered to respective clients as separate orders (e.g., by the order deliverer 612) (block 930). With respect to the composite order, the fills of the composite order are split (e.g., by the order divider 610 of FIG. 6) into a filled first order and a filled second order based on respective quantities of the first and second orders based on the digest.

Thus, the example method 900 provides for considerations of the effects of merging orders not only the order that has a smaller quantity and can benefit from association with a larger order, but also for the impact of the merging on the larger order and orders that are not combined with other orders. The example method 900 accounts for flexibility in setting permissions to selectively limit an order from being combined with another order in the event there is a reduction in a priority level. The example method 900 also balances filling orders that are not combined with other orders with composite orders so as not to disproportionally favor composite orders to the disadvantage of orders having attributes that are not matched with attributes of other orders or are not eligible for combining.

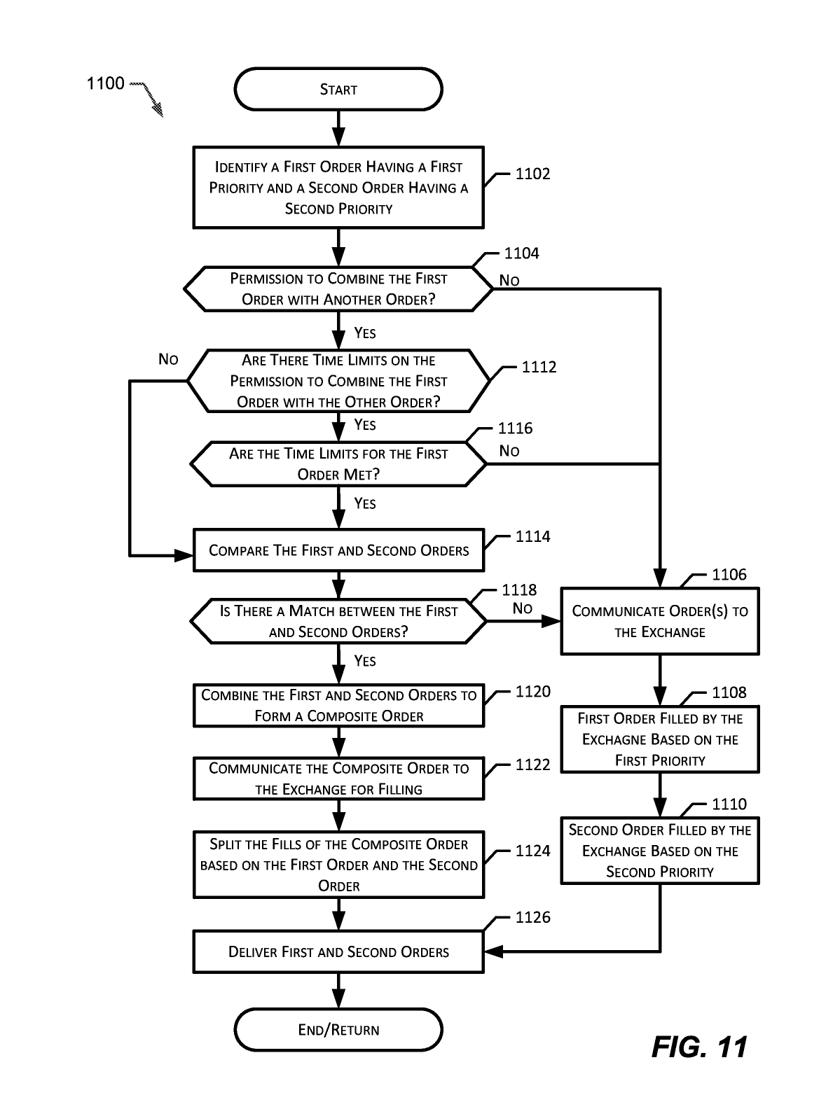

FIG. 11 is a flow diagram of an example method 1100 for combining orders. In particular, the example method 1100 considers one or more permissions or settings for combining an order with anther order. The example method 1100 includes identifying a first order having a first priority and a second order having a second priority (block 1102). The first order and the second order have associated attributes (e.g., a tradeable object for which the order is submitted, a price for the object, a quantity of the object, a originating client or trading device, etc.). The first and second priorities can be based on, for example, the quantities of the respective first and second orders. The first order and the second order can be identified by the order identifier 602 of the example system 600 of FIG. 6.

The example method 1100 includes a determination as to whether permission has been granted to combine the first order with another order (block 1104). For example, the permission identifier 603 of FIG. 6 can identify whether a user has set permissions with respect to the first order, including whether the first order is allowed to be combined with another other, is selectively allowed to be combined with another order, or is not permitted to be combined with another order. In some examples, upon detection of a permission setting, the permission identifier 603 flags first order as being permitted to be combined with another order. In other examples, the permission identifier 603 flags the first order if the first order is not allowed to merged with another order.

If the first order is not permitted to be combined with another order such as the second order, the first order is communicated and/or transferred to the exchange (block 1106) and filled as a separate order by the exchange based on the first priority (block 1108). In such examples, the second order can be communicated and/or transferred to the exchange as an individual order and filled by the exchange based on the second priority (block 1110).

If the first order is permitted to be combined with another order such as the second order, the example method 1100 considers whether there are any selective permissions associated with the first order. As described above in connection with the example permission identifier 603 of FIG. 6, a user can allow the first order to be combined with another order if certain conditions are met. Example conditions can include a threshold by which the quantity of the first order must increase when associated with the second order and/or company or broker credentials associated with the second order that must be met for the first order to be combined with the second order.

As an example of selective permission condition, the example method 1100 includes a determination whether there are any time limits on the permission granted for combining the first order with another order (block 1112). For example, a user setting can limit the availability of the first order for consideration for order combining to a predefined period of time. Before and after the predefined period, the first order is considered ineligible for order combining.

In the example method 1100, if there are no time limit restrictions for combining the first order with the second order, the example method continues with comparing the attributes of the first order and the second order (e.g., via the order comparer 604 of FIG. 6) to determine whether the first order and the second order share one or more attributes for combining the orders (block 1114).

If there are time limits associated with the first order, the example method 1100 includes a determination whether the time limits are met (block 1116). For example, the permission identifier 603 and/or the order comparer 604 can determine whether the first order is within an allowable time frame for being considered a potential candidate for combining with the second order.

If the time limit for considering the first order as a candidate for combining with another order is not met (e.g., the time limit has expired), the first order is transferred to the exchange for filling independently based on the first priority (blocks 1106, 1108). In some examples, the second order is transferred to the exchange for filling based on the second priority (block 1110).

If the time limit for considering the first order as a candidate for combining with another order is available or open, the example method 1100 proceeds with comparing the attributes of the first and second orders to determine if there is a match between, for example, the tradeable objects and prices associated with each order (block 1114). Comparing the first and second orders can be performed by the order comparer 604 of FIG. 6 as disclosed above.

The example method 1100 includes a determination whether there is a match between one or more attributes of the first and second orders (block 1118). If there is not a match between the first order and the second order, the example method 1100 proceeds with communicating the first and second orders to the exchange for filling as individual orders based on the first and second priorities (blocks 1106, 1108, 1110). In some examples, the second order may be considered for matching with another order to form a composite order with an order other than the first order. In such examples, the first order may be filled as an independent order while the second order is filled as part of a composite order.

If the first order and the second order share one or more of the same or substantially the same attributes, the example method 1100 continues with combining the first and second orders (e.g., via the order merger 606 of FIG. 6) to form a composite order (block 1120). Combining the orders to form the composite order can be achieved using one or more combination methods as described above in connection with the example method 700 of FIG. 7 and/or the example method 900 of FIG. 9 (e.g., creating a new order or modifying an existing order).

In the example method 1100, the composite order is communicated to the exchange and filled by the exchange (block 1122). The filled composite order is returned to, for example, a gateway (e.g., the gateway 404, 506a-506n of FIGS. 4 and 5) or an order combiner server (e.g., the order combiner 504 of FIG. 5). The example method 1100 includes splitting the filled quantities, or fills, of the composite order (e.g., via the order divider 612 of FIG. 6) based on the respective quantities of the first and second orders (block 1124). Splitting the fills of the composite order can be based on reference to, for example, a digest (e.g., a digest prepared by the digest recorder 608 of FIG. 6 at the time of combining the orders). The example method 1100 includes delivering the first and second orders to the respective clients (block 1126) whether the first and second orders were filled independently (e.g., blocks 1106, 1108, 1110) or as part of a composite order (e.g., blocks 1120, 1122).

Thus, the example method 1100 accounts for permission settings associated with the orders. The example method 1100 considers one or more levels of permission settings, including whether the order is allowed to be combined with another order and whether there are any conditions on the allowance to combine related to, for example, time periods for combining or quantity thresholds. In accommodating user-defined permissions, the example method 1100 provides users with a degree of control in determining how the order is filled in view of the option to join a composite order.

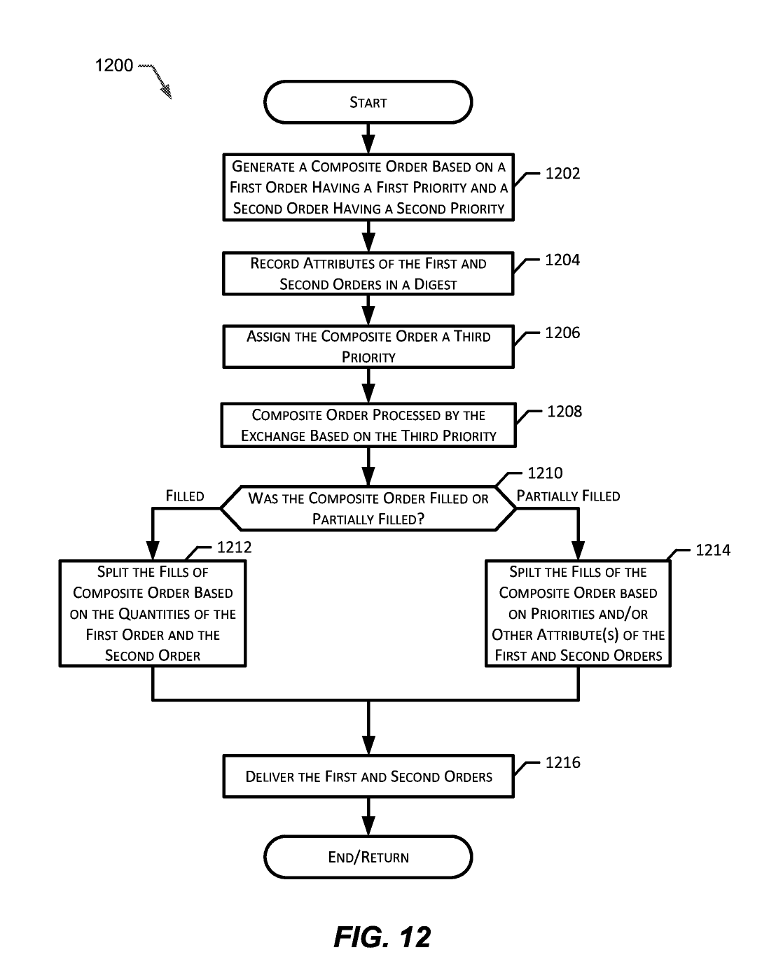

As described above in connection with the example methods 700, 900, 1100 of FIGS. 7, 9, and 11, a composite order can be created for filling two or more orders based on various parameters or rules, including, for example, shared order attributes, an effect of combining orders on the priority of one or more of the joined orders, user-defined permissions, etc. Filling the composite order can also include one more considerations in view of, for example, available resources at the exchange. FIG. 12 is a flow diagram of an example method 1200 for filling a composite order.

The example method 1200 includes generating a composite order based on a first order having a first priority in queue for filling the order and a second order having a second priority in the queue (block 1202). The composite order can be generated by the order merger 606 of FIG. 6. In some examples, the first and second priorities are based on quantities for a tradeable object associated with each order. In the example method 1200 the second priority is less than the first priority (e.g., the second order is for a lesser quantity than the first order). The composite order can be created using one or more of the example methods 700, 900, 1100 disclosed in connection with FIGS. 7, 9, and 11. For example, a composite order can be formed from the first order and the second order being associated with the same tradeable object for the same price, but differing in quantity. The example method 1200 includes recording the attributes of the first order and the second order that form the composite order (block 1204). For example, the digest recorder 608 of FIG. 6 can record the respective quantities associated with each order and the client from which each order originated in a digest.

In the example method 1200, the composite order is assigned a third priority (block 1206), which can be equal to or greater than one or more of the first priority or the second priority, as disclosed in connection with FIGS. 7-11. The third priority represents a placement of the composite order in a queue for filling the order at the exchange relative to other orders that are to be filled. The third priority can be based on, for example, the increased quantity of the composite order for the tradeable object as a result of merging the quantities of the first and second orders. The composite order is processed by the exchange based on the third priority (block 1208).

Although creating the composite order can increase the priority of one or more of the first order or the second order as a result of the increased quantity as compared to if the orders were filled alone, filling the composite order requires that exchange has a sufficient quantity of the tradeable object available. To account for scenarios where there may not be a sufficient number of objects available to fill the composite order, the example method 1200 includes a determination of whether the composite order was filled or partially filled by the exchange (block 1210). For example, if sufficient resources are available at the exchange to fill the quantities of the first order and the second order that form the composite order and the exchange provides those quantities to the composite order, then the composite order may be considered to be filled. However, if there are not sufficient resources at the exchange to completely fill the composite order and/or if, based on market activity or conditions, the exchange provides the composite order with a quantity less than the quantity equal to the amount of the first and second orders, then the composite order may be considered partially filled.

After filling or partially filling the composite order, the composite order is returned to the order combiner (e.g., the order combiner 410, 504 of FIGS. 4 and 5). In the example method 1200, the fills of the composite order are split (e.g., by the order divider 612) based on whether the composite order was filled or partially filled.

For example, if the composite order was filled such that quantities (e.g., the complete quantities) of the first and the second order were provided by the exchange, then the example method 1200 includes splitting the fills of the composite order based on the quantity of the first order and the quantity of the second order (block 1212). For example, the order divider 610 references the digest to split the order based on the quantities associated with the first order and the second order. Thus, when the composite order is filled by the exchange, each of the first order and the second order receive the respective quantities of objects for which the orders were submitted.

If the composite order was only partially filled due to, for example, a lack of sufficient available resources at the exchange, splitting the fills of the composite order can include distributing the filled quantities based on one or more attributes of the first and second orders (block 1214). For example, the fills of the partially filled composite order can be divided based on one or more of the first and second priorities of the respective first and second orders, the quantities of the first and second orders, times at which the first and second orders were submitted, and/or other attributes or rules for allocating filled quantities. In some examples, the filled quantities can be distributed such that the first order or the second order are completed and the other order is partially completed or not filled. In other examples, the filled quantities are allocated so that each of the first order and the second order receives a portion of the filled quantities.

The example method 1200 includes delivering the first order and the second order after the filling or the partial filling of the composite order (block 1216). In some examples, the order deliverer 612 of FIG. 6 delivers the first order and the second order to the respective clients. As described above, however, because in some examples there may not be sufficient resources available to fully fill the composite order, the order deliverer 612 may deliver a partially filled first order and/or a partially filled second order. If the first order and/or the second order are not completely filled as part of the composite order by the exchange, the first order and/or the second order can remain active for filling at the exchange, for example, as a composite order. In some examples, the composite order can be divided such that the first order and/or the second order are disassociated from the composite order and communicated to the exchange for filling as individual working orders (e.g., in an effort to fill a remainder of the first order and/or the second order). Also, one or more the first order or the second order can be suspended or cancelled in view of the incomplete filling by the exchange.

In some examples, the example method 1200 can optionally include checking and/or estimating the available resources (e.g., tradeable objects) at an exchange as part of, for example, combining the first order and the second order. Such checking provides for a determination of whether there are sufficient resources available to fill the composite order and an indication that the fills of the composite order may be divided based on order priority if there are not sufficient available resources. Checking the available resources can be performed by, for example, a gateway at which the composite order is created or received prior to being transferred to the exchange (e.g., the gateway 404, 506a-506n of FIGS. 4 and 5). The gateway can be in communication with the exchange via one or more network connections. In some examples, checking the resources at the exchange can be performed by the order combiner (e.g., the order combiner 410, 504 of FIGS. 4 and 5).

Thus, the example method 1200 accommodates examples where there may not be sufficient resources available to completely fill the composite order. The example method 1200 adjusts for such scenarios by splitting the fills of the composite order based one or more attributes of the first order and the second order, such as the priorities associated with each order. In some examples, the fills can be divided based on the original priorities of the first order and the second order (e.g., the first priority and the second priority). In such examples, filling the composite order can resemble filling the first order and the second order as separate orders. In other examples, the fills of the composite order can be divided so as to partially fill at least some of the first order and the second order. In such examples, the second order continues to benefit from the association with the first order as part of the composite order. In examples in which the composite order is partially filled, splitting the fills of the composite order can include distributing the filled quantities based on one or more rules or order attributes to equitably allocate a partially filled composite order.

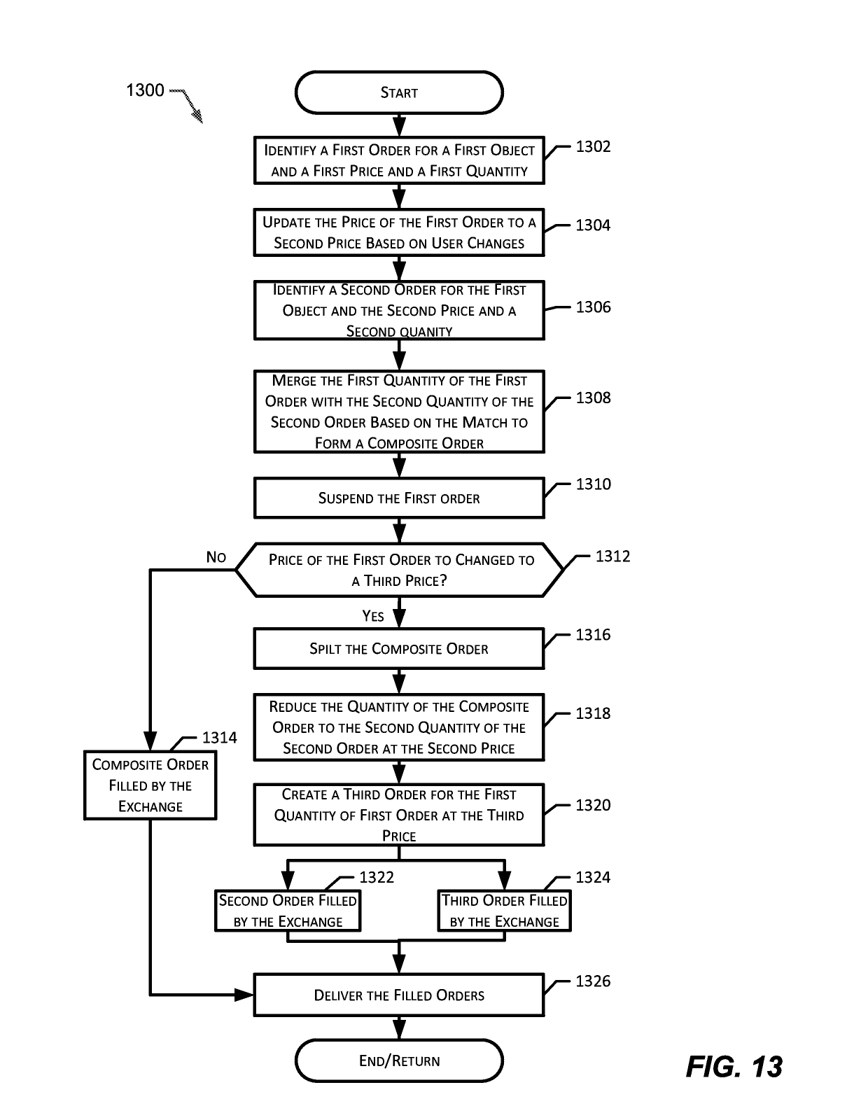

FIG. 13 is a flow diagram of an example method 1300 for dividing a composite order. In particular, the example method 1300 describes updating a composite order as result of a change to one or more attributes of a first order or a second order forming the composite order after the composite order has been created.

The example method 1300 includes identifying a first order associated with a first tradeable object for a first price and a first quantity (block 1302). The first order can be received by, for example, a gateway (e.g., the gateway 404, 506a-506n of FIGS. 4 and 5) and/or an order combiner (e.g., the order combiner 410, 504 of FIGS. 4 and 5). The first order can be identified by, for example, the order identifier 602 of FIG. 6.

After submitting the first order to the gateway and/or the order combiner, a user (e.g., a trader) may decide to change the first price of the order to a second price via, for example, a trading device. The example method 1300 includes updating the price of the first order to the second price in response the price change enacted by the user (block 1304). In some examples, the gateway and/or the order combiner updates the price of the first order in response to the user activity.

After the price update for the first order, the example method 1300 checks for other orders submitted to the gateway and/or the order combiner (e.g., previously submitted orders) that match or substantially match the first order and/or one or more attributes of the first order, such as the tradeable object and the price. For example, the method 1300 identifies a second order for the first object at the second price and a second quantity (block 1306) via, for example, the order identifier 602 of FIG. 6. The second quantity can be equal to or different from the first quantity. In view of the common order attributes between the first order and the second order, the example method 1300 includes merging the first quantity of the first order with the second quantity of the second order so as to modify the quantity of the second order to create a composite order (block 1308). The example method 1300 includes suspending and/or cancelling the first order in favor of the modified second order (block 1310).

In some examples, the trader of the first order may decide to change the price of the first order after the first order is associated with the composite order. As disclosed above, from the perspective of the user trading applications, the first order is viewed as a stand-alone order throughout the order submission, filling, and delivery process. Thus, users are provided with option to update one or more attributes of the first order after submitting the first order and before the first order is filled by the exchange.

The example method 1300 includes a determination of whether the price of the first order has been updated to a third price different from the second price (block 1312). If the price of the first order has not been updated, the composite order is communicated to and filled by the exchange (block 1314). The composite order can be filled by the exchange substantially as disclosed in connection with any of the example methods 700, 900, 1100, 1200 of FIGS. 7, 9, 11, and 12.

If price of the first order is updated to a third price after joining the composite order, the example method 1300 includes splitting the composite order (block 1316). As the first order and the second order are now associated with different prices, treating the first order and the second order as a composite order may no longer be appropriate. In particular, by updating the price of the first order, the user (e.g., the trader) has requested that the first order is filled at the new price. If the first order at the new price remained as part of the composite order, the first order may be filled at a different, and potentially a worse, price than the trader expects. Also, if the first order at the new price remained a part of the composite order, the price at which the second order is filled could also be affected and could be different than a price that the trader of the second order expected. Thus, splitting the composite order allows each order to be working for filling by the exchange at the price at which the trader(s) have requested.

To split the composite order, the quantity of the composite order is reduced to the quantity of the second order (e.g., the second quantity) (block 1318). Also, the example method 1300 includes creating a third order based on the first quantity of the first order at the third, or updated, price (block 1320). Thus, after splitting the composite order, the resultant orders include the second order for the second quantity at the second price (e.g., substantially resembling the second order prior to formation of the composite order) and a new, third order for the first quantity previously associated with the first order at the third price. In other examples, creating the third order for the first order at the updated price can including merging the first order with another order and/or another composite order that is also for the updated or third price. In some examples, splitting the composite order, reducing the quantity of the composite order, and creating the third order is performed by one or more components of the order combiner (e.g., the order divider 610, the order merger 606 of FIG. 6).

The second order and the third order are filled by the exchange (blocks 1322, 1324). As the second order and the third order are not associated with a composite order, the orders are filled by the exchange as stand-alone orders. In some examples, filling the second order and the third order is based on priority levels or rankings of the second order and the third order in the exchange queue. For example, the second order maybe filled before or after the third order based on, for example, the quantity of the second order relative to the quantity of the third order. Filling the orders can be achieved substantially as disclosed in connection with any of the example methods 700, 900, 1100, 1200 of FIGS. 7, 9, 11, and 12.

In the example method 1300, the filled orders are delivered to the originating clients (e.g., the traders who submitted the orders) (block 1326). Delivering the orders can be achieved substantially as disclosed in connection with any of the example methods 700, 900, 1100, 1200 of FIGS. 7, 9, 11, and 12 and by the order deliverer 612 of FIG. 6. If the composite order is not divided because of a price change of the first order (e.g., block 1314), the fills of the composite order are delivered after splitting the fills of the composite order into the first order and the second order based on the respective quantities of each order. However, if the price of the first order was updated after forming the composite order (e.g., blocks 1316, 1318, 1320), the fills of the second order and the third order do not need to be divided, as the orders were previously disassociated from the composite order as a result of the price update to the first order. In some examples, if the third order is a composite order including the first order at the new price and one or more other orders, the fills of the third order are divided based on the respective orders comprising the third order.

The example method 1300 illustrates the responsive nature of order combining in view of changes to the orders after generating the composite order. As described in FIG. 13, although an order may be combined with another order, a trader can still update and/or change the order in view of, for example, changes in market conditions. The example method 1300 re-evaluates the composite order in view of such changes and updates the composite order if needed. The example method 1300 can be implemented for changes to other attributes of the first and/or second order after forming the composite order, such as changes in a tradeable object associated with an order or a cancellation of an order. Thus, in addition to providing an order with potential benefits through an increased priority in order filling by association with the composite order, the example method 1300 also provides for flexibility in responding to order changes before and/or after the creation of the composite order.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method, comprising:
identifying a first order for a first tradeable object in a queue, the first order having a first quantity and a first price;
determining an equivalency between the first tradeable object and the first price and a second tradeable object and a second price of a second order in the queue;
if an equivalency is determined, generating a composite order based on the first order and the second order, the composite order to be recognized by an exchange;
receiving a filled composite order from the exchange configured to process the generated composite order; and
delivering a first portion of the filled composite order as the first order and a second portion of the filled composite order as the second order.

2. The method of claim 1, wherein determining the equivalency comprises:
performing a comparison between the first tradeable object and the first price and the second tradeable object and the second price; and
if, based on the comparison, the first tradeable object and the first price are substantially the same as the second tradeable object and the second price, identifying the first order and the second order as candidates for the composite order.

3. The method of claim 1, wherein generating the composite order comprises:
merging the first quantity of the first order with the second quantity of the second order; and
cancelling the first order.

4. The method of claim 1, wherein generating the composite order comprises:
merging the first quantity of the first order with the second quantity of the second order to form a third order, the third order to serve as the composite order; and
cancelling the first order and the second order.

5. The method of claim 1, wherein the first order has a first priority in the queue and the second order has a second priority in the queue and further comprising assigning the composite order a third priority in the queue, the third priority substantially equal to or greater than one or more of the first priority or the second priority.

6.-9. (canceled)

10. The method of claim 1, further comprising:
recording a composition of the composite order in a digest, the digest to maintain the first tradeable object, the first price, and the first quantity of the first order and the second tradeable object, the second price, and the second quantity of the second order; and
attributing the first portion of the filled composite order to the first order and the second portion of the filled composite order to the second order based on the composition recorded in the digest.

11. The method of claim 1, wherein the first order includes a first identifier and the second order includes a second identifier, the first identifier and the second identifier each indicating an allowance to combine the respective first order and second order with another order and wherein generating the composite order further comprises:
verifying the first identifier associated with the first order and the second identifier associated with the second order; and
merging the first quantity of the first order with the second quantity of the second order based on the verification of the first identifier and the second identifier.

12.-19. (canceled)

20. A tangible computer readable storage medium comprising instructions that, when executed, cause a machine to at least:
identify a first order for a first tradeable object in a queue, the first order having a first quantity and a first price;
determine an equivalency between the first tradeable object and the first price and a second tradeable object and a second price of a second order in the queue;
if an equivalency is determined, generate a composite order based on the first order and the second order, the composite order to be recognized by an exchange;
detect a filled composite order received from the exchange configured to process the generated composite order; and
deliver a first portion of the filled composite order as the first order and a second portion of the filled composite order as the second order.

21. The tangible computer readable storage medium of claim 20, wherein to determine the equivalency, the instructions cause the machine to:
perform a comparison between the first tradeable object and the first price and the second tradeable object and the second price; and
if, based on the comparison, the first tradeable object and the first price are substantially the same as the second tradeable object and the second price, identify the first order and the second order as candidates for the composite order.

22. The tangible computer readable storage medium of claim 20, wherein to generate the composite order, the instructions cause the machine to:
merge the first quantity of the first order with the second quantity of the second order; and
cancel the first order.

23. The tangible computer readable storage medium of claim 20, wherein to generate the composite order, the instructions cause the machine to:
merge the first quantity of the first order with the second quantity of the second order to form a third order, the third order to serve as the composite order; and
cancel the first order and the second order.

24. The tangible computer readable storage medium of claim 20, wherein the first order has a first priority in the queue and the second order has a second priority in the queue and the instruction further cause the machine to assign the composite order a third priority in the queue, the third priority substantially equal to or greater than one or more of the first priority or the second priority and further comprising filling the composite order based on the third priority.

25. The tangible computer readable storage medium of claim 20, wherein the instructions cause the machine to:
record a composition of the composite order in a digest, the digest to maintain the first tradeable object, the first price, and the first quantity of the first order and the second tradeable object, the second price, and the second quantity of the second order; and
attribute the first portion of the filled composite order to the first order and the second portion of the filled composite order to the second order based on the composition recorded in the digest.

26. The tangible computer readable storage medium of claim 20, wherein the first order includes a first identifier and the second order includes a second identifier, the first identifier and the second identifier each indicating an allowance to combine the respective first order and second order with another order and wherein to generate the composite order, the instructions cause the machine to:
verify the first identifier associated with the first order and the second identifier associated with the second order; and
merge the first quantity of the first order with the second quantity of the second order based on the verification of the first identifier and the second identifier.

27. A system comprising a computing device including a processor configured to:
identify a first order for a first tradeable object in a queue, the first order having a first quantity and a first price;
determine an equivalency between the first tradeable object and the first price and a second tradeable object and a second price of a second order in the queue;
if an equivalency is determined, generate a composite order based on the first order and the second order, the composite order to be recognized by an exchange;
detect a filled composite order received from the from the exchange configured to process the generated composite order; and
deliver a first portion of the filled composite order as the first order and a second portion of the filled composite order as the second order.

28. The system of claim 27, wherein to determine the equivalency, the processor is configured to:
perform a comparison between the first tradeable object and the first price and the second tradeable object and the second price; and
if, based on the comparison, the first tradeable object and the first price are substantially the same as the second tradeable object and the second price, identify the first order and the second order as candidates for the composite order.

29. The system of claim 27, wherein to generate the composite order, the processor is configured to:
merge the first quantity of the first order with the second quantity of the second order; and
cancel the first order.

30. The system of claim 27, wherein to generate the composite order, the processor is configured to:
merge the first quantity of the first order with the second quantity of the second order to form a third order, the third order to serve as the composite order; and
cancel the first order and the second order.

31. The system of claim 27, wherein the first order has a first priority in the queue and the second order has a second priority in the queue and the processor is configured to assign the composite order a third priority in the queue, the third priority substantially equal to or greater than one or more of the first priority or the second priority and further comprising filling the composite order based on the third priority.

32. The system of claim 27, wherein the processor is configured to:
record a composition of the composite order in a digest, the digest to maintain the first tradeable object, the first price, and the first quantity of the first order and the second tradeable object, the second price, and the second quantity of the second order; and
attribute the first portion of the filled composite order to the first order and the second portion of the filled composite order to the second order based on the composition recorded in the digest.
